(19) United States
(12) Patent Application Publication
(10) Pub. No.: US 2016/0034769 A1
(43) Pub. Date: Feb. 4, 2016

(54) VEHICLE VISION SYSTEM WITH TRAFFIC SIGN RECOGNITION

(71) Applicant: MAGNA ELECTRONICS INC., Auburn Hills, MI (US)

(72) Inventor: Harjeet Singh, Aschaffenburg (DE)

(21) Appl. No.: 14/810,798

(22) Filed: Jul. 28, 2015

Related U.S. Application Data
(60) Provisional application No. 62/030,212, filed on Jul. 29, 2014.

(51) Int. Cl. G06K 9/00; G06K 9/32; H04N 7/18

(52) U.S. Cl. CPC G06K 9/00818; H04N 7/183; G06K 9/3241

(57) ABSTRACT

A vision system of a vehicle includes at least one camera configured to be disposed at a vehicle so as to have a field of view exterior of the vehicle. The camera includes a pixelated imaging array having a plurality of photosensing elements. An image processor is operable to process image data captured by the camera. The image processor, responsive at least in part to image processing of captured image data and responsive at least in part to a signal indicative of a current geographical location of the vehicle, is operable to identify a determined sign at the road along which the vehicle is traveling.

### CROSS REFERENCE TO RELATED APPLICATION

The present application claims the filing benefits of U.S. provisional application Ser. No. 62/030,212, filed Jul. 29, 2014, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a vision system or imaging system or traffic sign recognition system for a vehicle that utilizes one or more cameras (preferably one or more CMOS cameras) to capture image data representative of images exterior of the vehicle, and provides enhanced sign recognition based at least in part on the current geographical location of the vehicle. For example, the system may include an image processor operable to process image data captured by the camera, and the image processor, responsive at least in part to image processing of captured image data and responsive at least in part to a signal indicative of a current geographical location of the vehicle, is operable to determine a sign at the road along which the vehicle is traveling. The image processor, responsive at least in part to a signal indicative of a current geographical location of the vehicle, thus may adjust processing of captured image data to identify a determined sign at the road along which the vehicle is traveling.

Optionally, for example, the vision system, responsive to the signal being indicative of the vehicle being at or near a particular region or city, processes captured image data to compare sign colors and sign text of the determined sign to stored colors and text associated with known signs of the particular region or city.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a schematic of a combination traffic sign recognition system and navigation system in accordance with the present invention;

FIG. 3 shows various different signs indicating entry into or exit from cities in different countries; and

FIG. 4 shows an optional placement of a sign at a corner or intersection.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

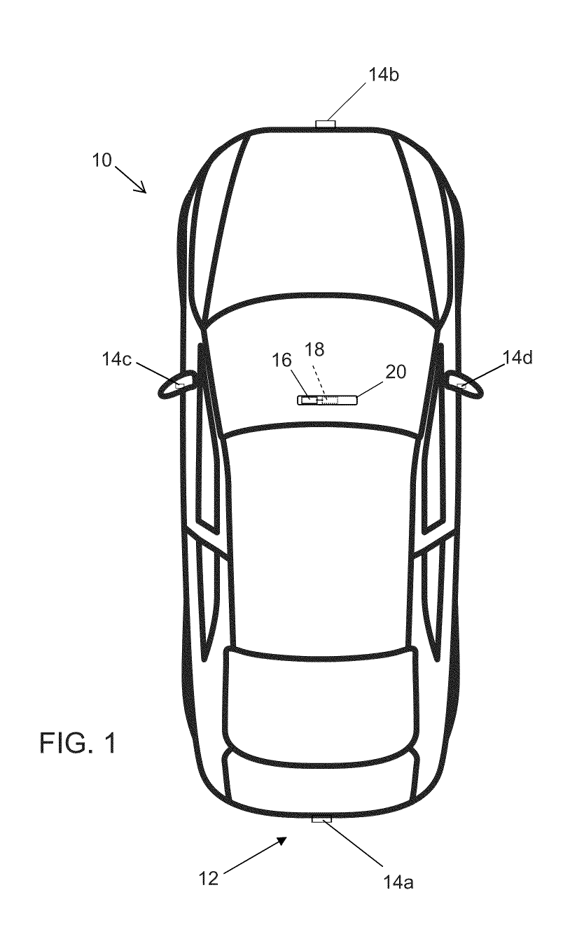

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Traffic Sign Recognition (TSR) is a feature which is becoming more and more common in present vehicles. TSR can be implemented with a camera recognizing the signs on the road, and displaying it to the driver, or as a pre-defined value in the navigation system, or the combination of both, in which both data are fused together and then the decisions are made for the applicable current speed limit.

The camera based system can have some disadvantages, such as to classify (or cluster) the city entrance and city exit signs, which are placed on the road and means that the specific country or state relevant speed is applicable for the area. The challenge with these signs are that they have different city names on them depending on the city that the driver is entering or leaving. This makes the image processing by the image processor and camera difficult to recognize these signs easily, and if the matching score for an image processing template is reduced then the chances of false detection or ghost detection increases.

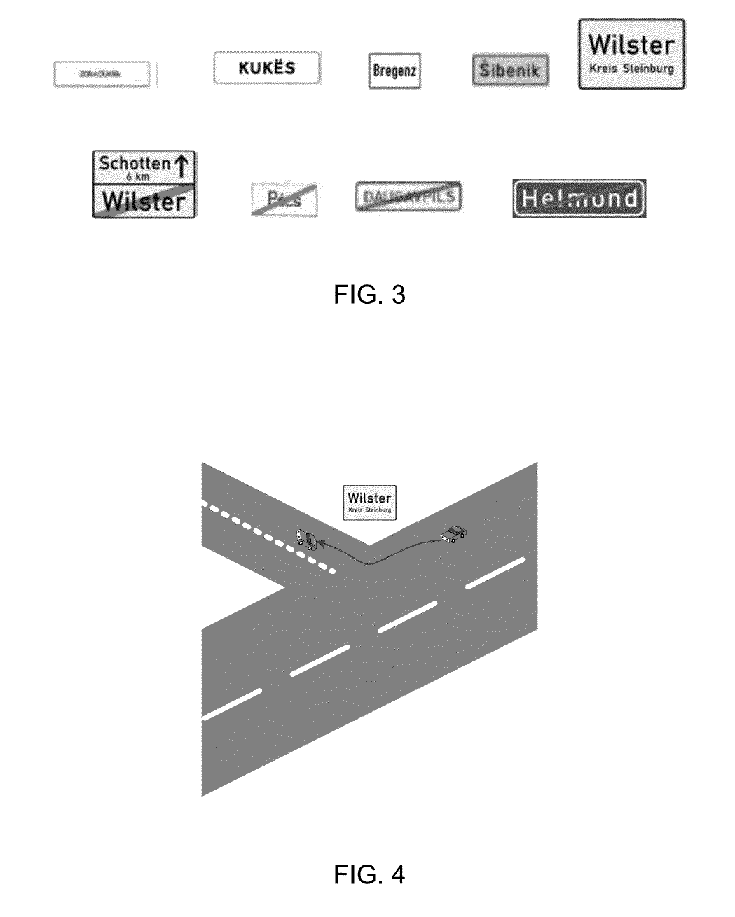

Some of the examples of city entrance signs and city exit signs from different countries are shown in FIG. 3. And also there are certain situations (such as shown in FIG. 4) where the city entry signs are placed at the corners of the roads which may not be in the field of view of the vehicle camera.

In order to avoid these situations, the navigation data is used. But one cannot rely on single navigation parameter as well, for example navigation have the options of give the information of buildup area, posted speed limits (PSL) and other extra information. So the buildup area can also be outside the city and the PSL can also be as the city speed limit outside the town and the road class can also be different.

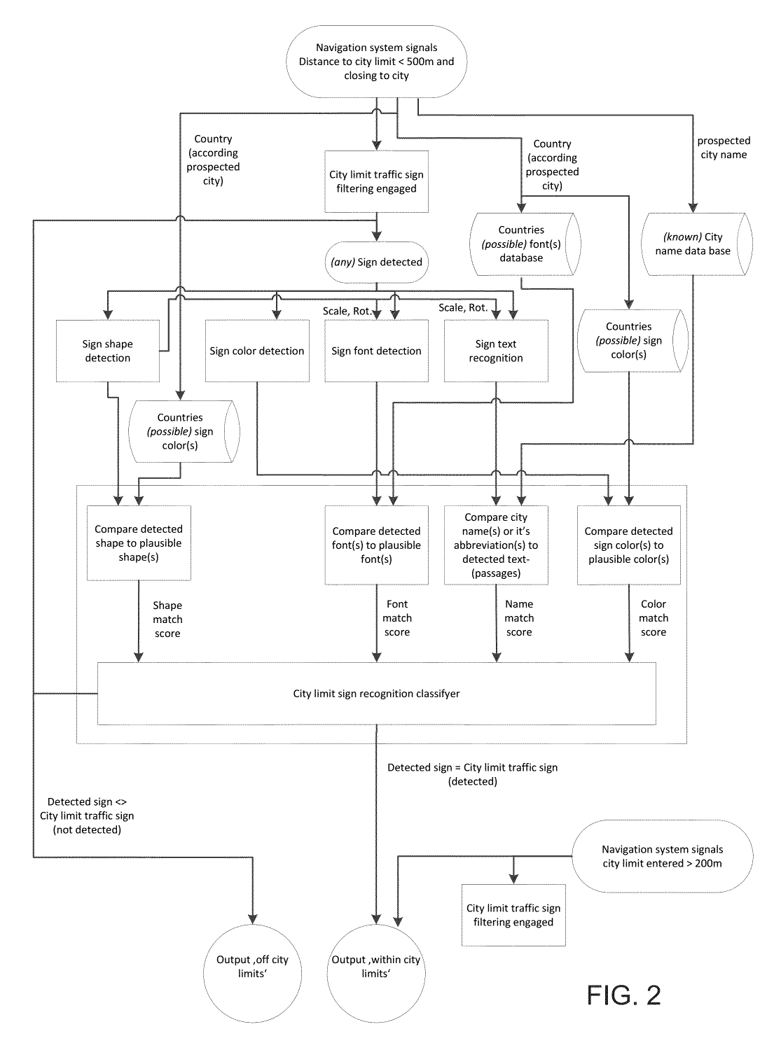

The present invention provides a system (such as shown in FIG. 2) that combines the navigational signal to determine the city at which the vehicle is entering or exiting. By combining the navigation signal logically in order to define whether the vehicle is entering a city or exiting a city, such as by processing to determine which city the vehicle may be close to (from navigation system), and logically by that determining in which country or state the vehicle is driving at and by that determining the types of city limit signs that are expected (internal classifier data base) in terms of shape (including height to width ratios), used font(s) and color, the information can be more accurate and can be used to display to the driver or to switch modes of automated or assisting systems between ‘out of city’ modes or ‘within city’ modes. The combination is mixed with the internal parameters which may be prior trained and stored (such as in a memory of the system or processor and/or in a stored look up table or the like) for different countries differently and switched to the specific country or state's data set when the vehicle crosses a country's border. The ‘City Limit Sign Classifier’ of FIG. 2 shows for inputs: ‘Compare detected shape to plausible shape(s)’, ‘Compare detected font to plausible fonts(s)’, ‘Compare detected sign color(s) to plausible color(s)’ and ‘Compare city names(s) or it's abbreviation(s) to detected text (passages)’. All these inputs come with a scoring which are the rates of possibility that a prior stage detected shape-, font-, color- and text fit to a closest match found in a data base.

The color detector, the text detector as well as the font detector may employ a text recognition which may be based for example on vector representation or such as Naïve Bayes, Rocchio, K nearest neighbor, Support vector machine (SVM), vector space modeling, hierarchical graph structuring or hybrids of these. The shape detector may use an appearance-based method such as a Canny edge matching to templates or a feature based method such as a kind of pose clustering or SIFT, possibly using a Hough transform or a wavelet transform as an input, possibly using consecutive cluster methods of one named above. Both the text and the font detector may optionally receive a scale and rotational parameters as inputs from the shape detector for improving the detection capabilities.

As another option, the TSR system of the present invention may be able to detect the crossing of a country's border by processing border signs detected visually by a camera and navigation system's data in combination similar to the city limit sign detection specified above. The visual clustering or classifier may use text (of the countries' names), (the font and sign's shape may be not standardized and by that not be usable as a parameter) and optionally may have a class with the country's flag color and shape stored since often the flag colors are displayed within signs when crossing a border. The navigation system may also provide whether it is possible being near a border (such as, for example, at or near or within about 500 m of a border).

Thus, the image processor, responsive at least in part to a signal indicative of a current geographical location of the vehicle, may adjust processing of captured image data to, using the stored or known information (stored in memory and optionally in a stored look up table or the like) pertaining to the current geographical location of the vehicle, identify a determined sign at the road along which the vehicle is traveling.

The vision system may utilize one or more cameras or sensors at the vehicle, such as forward viewing cameras or the like. The camera may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, which are all hereby incorporated herein by reference in their entireties.

Optionally, the vision system may include a display for displaying images captured by one or more of the imaging sensors for viewing by the driver of the vehicle while the driver is normally operating the vehicle. Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera configured to be disposed at a vehicle so as to have a field of view exterior of the vehicle;
wherein said camera comprises a pixelated imaging array having a plurality of photosensing elements;
an image processor operable to process image data captured by said camera to detect signs at the road along which the vehicle is traveling; and
wherein said image processor, responsive at least in part to image processing of captured image data and responsive at least in part to a signal indicative of a current geographical location of the vehicle, is operable to identify a determined sign at the road along which the vehicle is traveling.

2. The vision system of claim 1, wherein said image processor, responsive at least in part to the signal indicative of the current geographical location of the vehicle, adjusts processing of captured image data to identify the determined sign at the road along which the vehicle is traveling.

3. The vision system of claim 1, wherein said image processor, responsive at least in part to the signal indicative of the current geographical location of the vehicle, processes captured image data to compare properties of the determined sign with sign properties associated with known signs of the current geographical location of the vehicle.

4. The vision system of claim 1, wherein said vision system, responsive to said signal being indicative of the vehicle being at or near a particular city, processes captured image data to compare properties of the determined sign with sign properties associated with known signs of the particular city in which the vehicle is traveling.

5. The vision system of claim 4, wherein said vision system compares properties of the determined sign with sign properties via a classification process.

6. The vision system of claim 5, wherein one of the sign properties comprises a shape of the sign.

7. The vision system of claim 5, wherein one of the sign properties comprises a height to width ratio of the sign.

8. The vision system of claim 5, wherein one of the sign properties comprises a color of the sign.

9. The vision system of claim 5, wherein one of the sign properties comprises text of the sign.

10. The vision system of claim 9, wherein said vision system determines if the text is associated with known signs of a particular city at or near the current geographical location of the vehicle.

11. The vision system of claim 5, wherein one of the sign properties comprises the sign's text font associated with known signs of the country or at or near the current geographical location of the vehicle.

12. The vision system of claim 1, wherein said camera, when disposed at the vehicle, has its field of view forward of the vehicle and through a windshield of the vehicle.

13. A vision system of a vehicle, said vision system comprising:
a camera configured to be disposed at a vehicle so as to have a field of view exterior of the vehicle;
wherein said camera comprises a pixelated imaging array having a plurality of photosensing elements;
an image processor operable to process image data captured by said camera to detect signs at the road along which the vehicle is traveling;
wherein said image processor, responsive at least in part to image processing of captured image data and responsive at least in part to a signal indicative of a current geographical location of the vehicle, is operable to identify a determined sign at the road along which the vehicle is traveling; and
wherein said image processor, responsive at least in part to the signal indicative of the current geographical location of the vehicle, processes captured image data to compare properties of the determined sign with stored sign properties stored in memory of said system, with the stored sign properties being representative of signs at the current geographical location of the vehicle.

14. The vision system of claim 13, wherein said image processor, responsive at least in part to the signal indicative of the current geographical location of the vehicle, adjusts processing of captured image data to identify the determined sign at the road along which the vehicle is traveling.

15. The vision system of claim 13, wherein said vision system compares properties of the determined sign with stored sign properties via a classification process.

16. The vision system of claim 15, wherein the sign properties comprises at least one of (i) a shape of the sign, (ii) a height to width ratio of the sign, (iii) a color of the sign and (iv) text of the sign.

17. The vision system of claim 13, wherein said camera, when disposed at the vehicle, has its field of view forward of the vehicle and through a windshield of the vehicle.

18. A vision system of a vehicle, said vision system comprising:
a camera configured to be disposed at a vehicle so as to have a field of view exterior of the vehicle, wherein said camera, when disposed at the vehicle, has its field of view forward of the vehicle and through a windshield of the vehicle;
wherein said camera comprises a pixelated imaging array having a plurality of photosensing elements;
an image processor operable to process image data captured by said camera to detect signs at the road along which the vehicle is traveling;
wherein said image processor, responsive at least in part to image processing of captured image data and responsive at least in part to a signal indicative of a current geographical location of the vehicle, is operable to identify a determined sign at the road along which the vehicle is traveling; and
wherein said image processor, responsive at least in part to the signal indicative of the current geographical location of the vehicle, adjusts processing of captured image data to identify the determined sign at the road along which the vehicle is traveling.

19. The vision system of claim 18, wherein said image processor, responsive at least in part to the signal indicative of the current geographical location of the vehicle, processes captured image data to compare properties of the determined sign with stored sign properties associated with signs of the current geographical location of the vehicle, and wherein said vision system compares properties of the determined sign with stored sign properties via a classification process.

20. The vision system of claim 18, wherein the sign properties comprises at least one of (i) a shape of the sign, (ii) a height to width ratio of the sign, (iii) a color of the sign and (iv) text of the sign.
